(19) United States
(12) Patent Application Publication
(10) Pub. No.: US 2017/0074617 A1
(43) Pub. Date: Mar. 16, 2017

(54) METHOD AND SYSTEM FOR DETECTION AND TRACKING OF HOLSTERING AND UNHOLSTERING

(71) Applicant: Yardarm Technologies, Inc., Capitola, CA (US)

(72) Inventors: Robert J. Stewart, Soquel, CA (US); David Glowacki, San Francisco, CA (US); James Schaff, Pacifica, CA (US); Kyle Howell, Atlanta, GA (US); Tom Tooley, Alpharetta, GA (US); John Wade, Alpharetta, GA (US)

(21) Appl. No.: 14/986,139

(22) Filed: Dec. 31, 2015

Related U.S. Application Data
(60) Provisional application No. 62/283,807, filed on Sep. 14, 2015.

(51) Int. Cl. F41C 33/02; G08B 5/22; H04W 4/02; G08B 25/10; H04W 4/00

(52) U.S. Cl. CPC F41C 33/029; G08B 25/10; H04W 4/008; H04W 4/023; G08B 5/22

(57) ABSTRACT

Disclosed herein are apparatuses, systems, and methods for monitoring the status of an implement at a mount. A communications channel may be established between a mount (e.g., holster) telematics device and local and/or remote monitoring service components, sometimes by means of intermediary devices. When the telematics device detects that its associated firearm is removed from its holster, the change in status can be reported to the local and/or remote system.

### CROSS-REFERENCE TO RELATED APPLICATIONS

This application claims the benefit of U.S. Provisional Application No. 62/283,807, filed Sep. 14, 2015, which is incorporated by reference in its entirety.

### FIELD OF THE INVENTION

The present invention relates to apparatuses, systems, and methods for providing services concerning detecting and tracking holstering and unholstering.

### BACKGROUND

Systems exist for detection of the presence or absence of an object; as an example, a vehicle or person may break a light beam, halting a closing garage door.

Serious incidents for security and law enforcement personnel often involve use or anticipated use of a firearm, which may be initiated by an operator removing a firearm or other implement from a mount (e.g., a holster), and thus it may be helpful to enable real-time communication of such events. The ability to communicate, in real-time, whether an operator has drawn the operator's weapon or other implements has many important applications. For example, real-time communication of an unholstering event may help to keep a command center or supervisor apprised of the status of activities in the field. Such communication may also be useful for a team of operators to stay on top of a coordinated operation, particularly in situations where the team members are unable to speak (e.g., they may be wearing gas masks, staying hidden, or are out-of-earshot) or unable to directly observe what other team members are doing.

Systems involving detecting unholstering have been contemplated—for example, U.S. Pat. Pub. No. 2015/0256990 A1 to Vilrokx et al., describes a system for processing incoming messages from a “smart holster.” The smart holster detects unholstering of a weapon using a pressure sensor (or alternatively, a contact switch). A predictive model is used to process the incoming wireless signals to generate real-time alerts, which alerts are in turn sent to the wireless-enabled holster. The system includes a rule server configured to query a database to retrieve one or more rules, and to apply the one or more rules over the incoming wireless signals. However, this system has drawbacks—for example, it doesn't teach or suggest techniques for detecting unholstering other than use of a pressure sensor or a contact switch. Additionally, it does not suggest coordination of sensor devices using a hub device, such as a mobile device, or local communication between sensor devices worn by separate operators, or pre-loading rules for controlling alerting and other outcomes at the smart holster or a hub device, which would permit faster reaction time and would allow a team to share communications even in the absence of a communication/data connection to a remote server or command center.

Drawbacks that are particularly relevant to contact-related unholstering detection techniques relate to the fact that contact-related sensors as taught in Vilrokx et al. would typically be positioned inside the holster (such as the pressure sensor 114(2)) or at a latch of the holster (such as contact switch sensor 114(3)). This design may have dangerous consequences: If dislodged or damaged, the components of the mechanism could cause items, parts, or debris within the holster to impede drawing a firearm, or possibly enter a trigger guard area, leading to a discharge event.

In another example, in U.S. Pat. No. 9,140,509 to Sullivan et al., a gun-mounted “electronic evidence-collecting device”—e.g., a camera—is activated by the removal of the gun from its holster. Specifically, a light sensor mounted on the gun is covered when the gun is holstered, and when the gun is removed from its holster, the light sensor receives light and initiates the collection of gun-related data from sensors on the gun, and the sensed, gun-related data is forwarded to a portable device (e.g., a smartphone), which may then automatically call the user's partner and/or the central station to request assistance and backup. However, Sullivan's system has drawbacks—for example, it only contemplates activating data recording only in response to unholstering as measured by a light sensor. Additionally, Sullivan's system does not contemplate enabling real-time, granular event and location-based remote monitoring by integrating with a distributed system.

Detecting and interpreting of the status of weapons, and associated equipment, as might be found on the belt or in the vehicle of a police officer or security guard or soldier, presents unique challenges which this invention addresses. For example, embodiments of the invention described below enable real-time monitoring of drawing a weapon or other mounted implement both locally by a team, as well as remotely, by, for example, a command center. Embodiments of the invention additionally provide for holster sensors that do not interfere with a holster or require permanent modification of a holster to function, to facilitate installation and compatibility with existing equipment.

### BRIEF DESCRIPTION OF THE DRAWINGS

The aspects and advantages of the invention will become more apparent upon consideration of the following detailed description, taken in conjunction with the accompanying drawings, in which like reference characters refer to like parts throughout, and in which:

FIG. 1 shows views of a telematics device for mounting on a mount, and exemplary telematics devices mounted on holsters, in accordance with some embodiments of the invention;

FIG. 2 shows views of an exemplary holster telematics device, in accordance with some embodiments of the invention;

FIG. 3 shows views of an exemplary holster telematics device, in accordance with some embodiments of the invention;

FIG. 4 shows views of an exemplary holster telematics device, in accordance with some embodiments of the invention;

FIG. 5 shows exemplary data concerning monitoring the status of an implement on a mount using a dielectric-shift-based mechanism, in accordance with some embodiments of the invention.

FIG. 6 shows views of an exemplary holster telematics device, in accordance with some embodiments of the invention;

FIG. 7 shows a block diagram of a telematics device in communication with a mobile device/hub, in accordance with some embodiments of the invention;

FIG. 8 shows three exemplary user interfaces for use in a system including monitoring of implement status on a mount, in accordance with some embodiments of the invention;

FIG. 9 shows an exemplary user interface for use in a system including monitoring of implement status on a mount, in accordance with some embodiments of the invention;

FIG. 10 shows an exemplary user interface for use in a system including monitoring of implement status on a mount, in accordance with some embodiments of the invention;

FIG. 11 is a block diagram showing exemplary data flows for an exemplary system in accordance with some embodiments of the invention;

FIG. 12 is a flow chart depicting an exemplary method for monitoring the status of an implement on a mount, in accordance with some embodiments of the invention;

FIG. 13 is a block diagram showing an exemplary mobile computing device, consistent with some embodiments of the invention;

FIG. 14 is a block diagram showing an exemplary computing device, consistent with some embodiments of the invention;

FIG. 15 is a block diagram showing an exemplary computing system, consistent with some embodiments of the invention.

FIG. 16 shows views of an exemplary holster telematics device, in accordance with some embodiments of the invention;

FIG. 17 shows views of an exemplary holster telematics device, in accordance with some embodiments of the invention;

FIG. 18 shows views of an exemplary holster telematics device, in accordance with some embodiments of the invention;

### DETAILED DESCRIPTION

Disclosed herein are systems, and methods for implementing a device and service for monitoring the status of an implement on a mount. Embodiments of the present invention provide a mount, such as a holster, equipped with certain specialized electronic circuitry, hereafter referred to as a telematics device. In certain embodiments, the telematics device detects when a firearm or other implement is present or absent from a mount.

As used herein, a “telematics device” refers to a device for detecting and/or recording information derived from the environment of the device, and where the device has one-way or two-way communications capability.

As used herein, a “firearm” refers to a ranged weapon, including a handgun, rifle, Conducted Electrical Weapon (CEW) (e.g., Taser®), or additional types of weapons capable of firing a bullet. Certain embodiments of the disclosure may be specifically adapted for one or more of handguns, rifles, or Tasers. Examples of nonlethal weapons include CEWs and batons. Examples of lethal weapons include handguns and rifles.

As used herein, a “mount” refers to a structure for holding a firearm or other implement. A mount may include a holster, gun rack (e.g., for longarm weapons), vest, or flak jacket.

As used herein, “real time” means information that is updated at least once every five seconds.

As used herein, “off-the-shelf” means a product not specifically designed to accommodate or work with a telematics device—for example, a stock weapon holster or mount with neither means for attaching nor otherwise accommodating a telematics device.

Disclosed are new methods and systems for remote detection of, for example, any belt holstered asset and its un-holstering and re-holstering. For example, consider the belted and holstered assets of a law enforcement officer, military personnel, or security guard. Such belt holster assets might include implements including firearms (e.g., ranged weapons, including handguns, rifles, and CEWs), ammunition-related implements such as ammunition clips, magazines, or cartridges for said firearms as well as pepper spray, flashlights, radios, cell phones, night sticks, or handcuffs. Some of these assets are removed or un-holstered for use only in unusual and potentially critical situations, else they are left in-place or holstered.

In one aspect, a monitoring service may include a sensor-based wireless communication device, e.g., a telematics device, so that un-holstering (or holstering) of a belted asset triggers wireless real-time wireless communication and/or notification of the un-holstering event to a remote command or dispatch center, or the like. The purpose of notification may be to enable informed command center decisions relative to the un-holstering event occurring in the field. The decisions might be to come to the immediate aid and assistance to the field personnel, thereby saving lives. Without a telematics device and monitoring service, command and dispatch may remain unaware of a mission critical event unfolding in the field during the most important timeframe, as radio communication may not be possible when personnel are busy and focused on the unfolding event, perhaps with two hands on their firearm or another asset/implement.

In certain embodiments, the telematics device is self-contained, self-powered, and logically connected, via wired or wireless means, to a listening device (e.g., a hub/mobile device, or a server). Further, in certain embodiments, the telematics device may support various methods for replenishing its power source, for example, direct cable or contact charging, inductive wireless charging, or harvesting the motion energy of an operator while deployed. In some embodiments, the telematics device is of ‘universal design’: capable of detecting a firearm or other weapon regardless of make and model, and independent of the cavity or container or holster used to house said weapon. In other embodiments, the telematics device may be optimized to the specifics of a weapon or container; for instance, optimizing for size and mechanical characteristics of specific cavities or containers or holsters.

The telematics device is mechanically sound. Some embodiments feature a hardened design, by means of remaining within the confines of the outer shape of the mount (e.g., container or pouch or holster). Some versions fully encapsulate their electronics within a moisture-proof and water-proof over-molded enclosure.

In certain embodiments, the apparatus is not internal to the cavity or container or holster or pouch, and thereby does not impede or endanger normal operation of the cavity or container or holster or pouch.

The apparatus makes use of a plurality of means of detection. These may be used alone or in combination, generically or in response to specific combinations of weapons and container.

In certain embodiments, the telematics device is equipped with a wireless transceiver. One embodiment includes the telematics device communicating with a smartphone, which relays the sensor's messages via wide-area or personal-area networks, which in turn connect with and relay the sensor's messages to other client devices (including mobile clients) and remote servers.

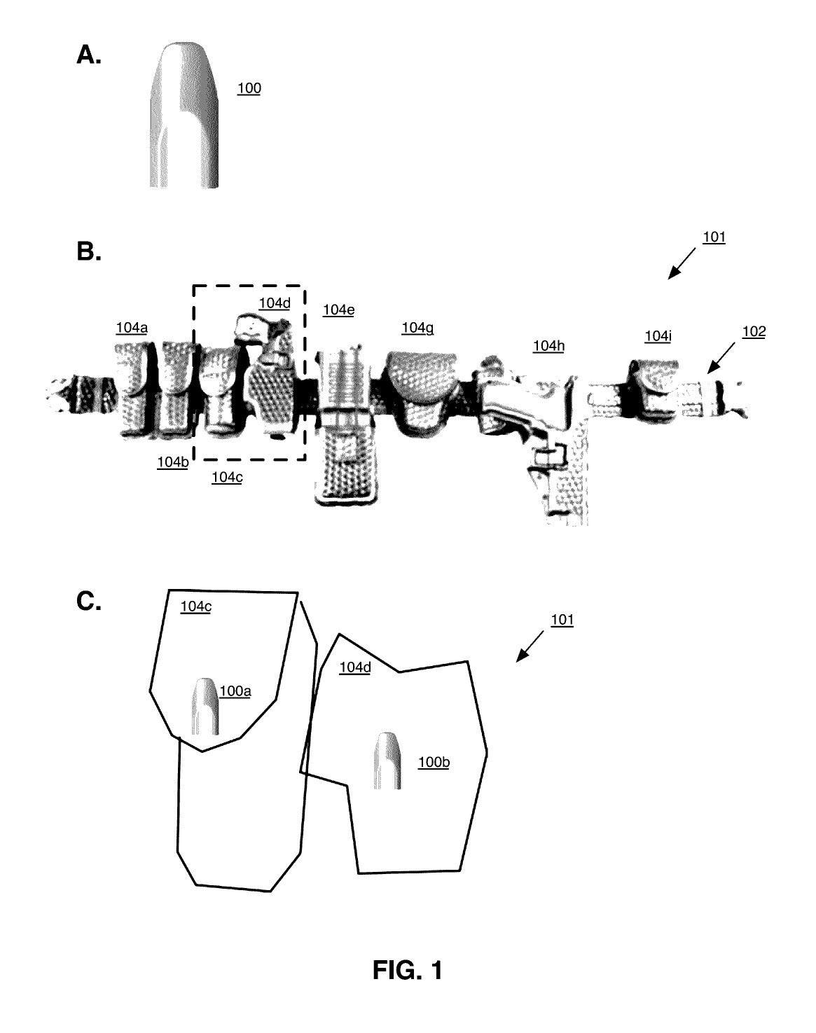

FIG. 1 shows views of exemplary telematics devices 100 for mounting on a mount, e.g., holsters 104. View 1A shows an isolated exemplary telematics device 100. View 1B shows components of an exemplary system 101 that makes use of telematics devices 100. System 101 includes a utility belt 102 with attached holsters 104a-i. Each of holsters 104a-i may incorporate a holster telematics device 100, for use in detecting when an instrument, such as a firearm, pepper spray, mace, baton, handcuffs, or a radio, is present or absent from the respective holster 104. As shown in View 1C, for example, holsters 104c and 104d from system 101 may each be associated with a respective telematics device 100. A telematics device 100 may be attached to a flap of holster 104, or may be attached to the exterior of holster 104, or may be integrated between or within the materials of holster 104. In certain embodiments, the telematics device 100 may be mounted on other types of mounts, such as a gun rack, vest, or flak jacket.

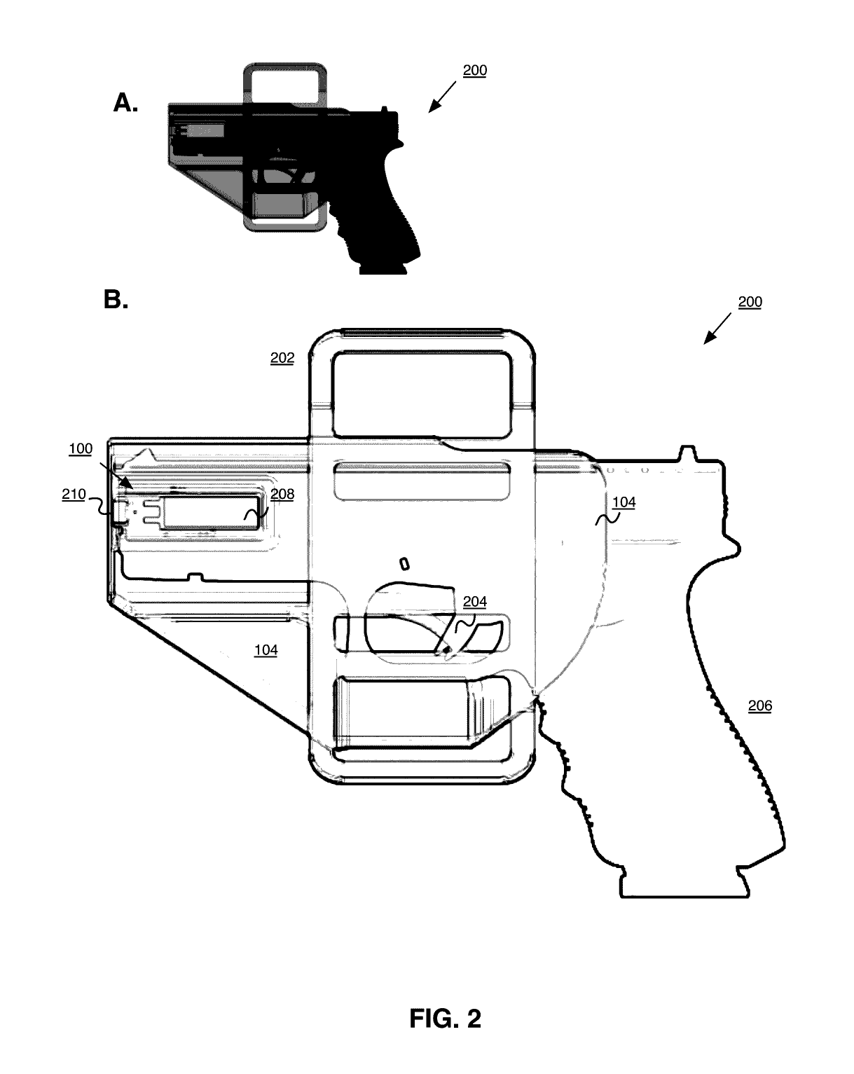

FIG. 2 shows views of an exemplary holster telematics system 200, including a holster telematics device 100 attached to a holster 104 having a belt clip 202, and where the holster 104 is shown to contain a holstered handgun with trigger 204 and grip 206. Holster telematics device 100 may include a battery 208 and a port 210. Port 210 may be, e.g., a coaxial power connector, a Universal Serial Bus (USB) port, a microUSB port, a Lightning™ port, and the like.

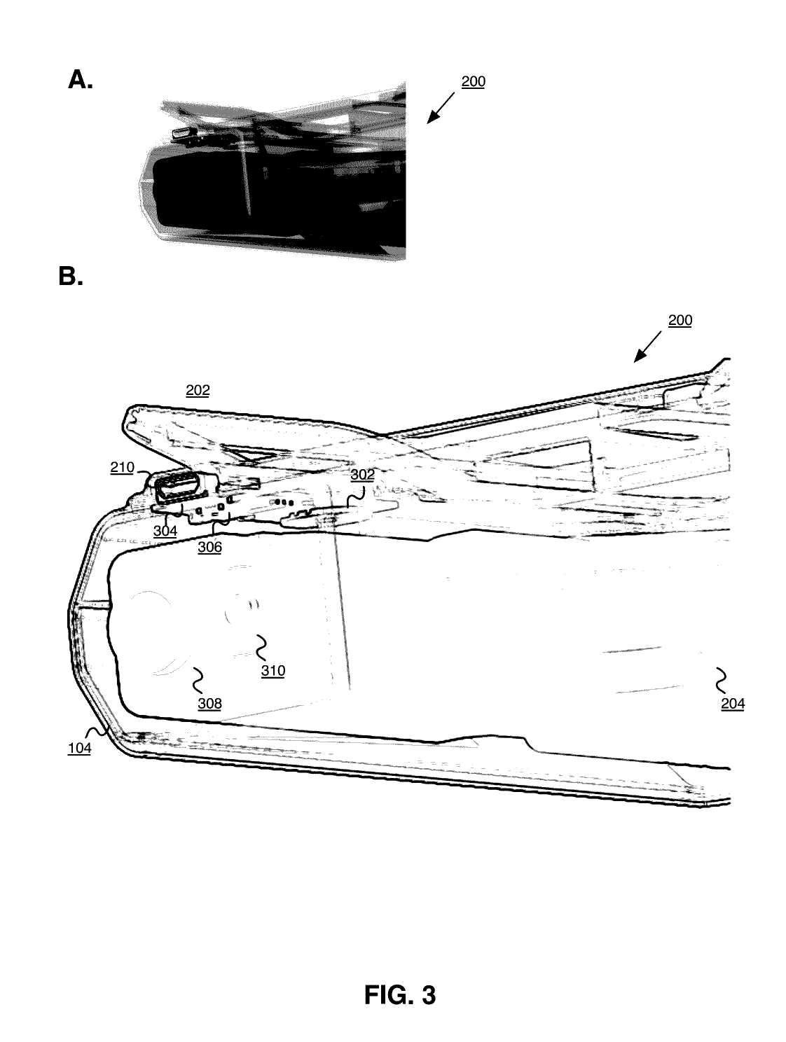

FIG. 3 shows views of an exemplary holster telematics system 200. View 3B shows a rotated view of the system 200 shown in FIG. 2. In the embodiment shown here, holster telematics device 100 includes an inductive coil 302 mounted on circuit board 304 with companion circuitry 306 for detecting the presence of a firearm based on the presence of the metal of the firearm (e.g., the receiver, muzzle 308, etc.). In certain examples, holster telematics device 100 may use inductive coupling, such as pulse induction or very low frequency (VLF) technology to detect whether a firearm is present based on the presence of metal, or components to measure the dielectric change when metal is present or absent, NFC to communicate between sensors on a firearm and a holster, or a light sensor to detect whether light is absent, indicating a firearm is holstered.

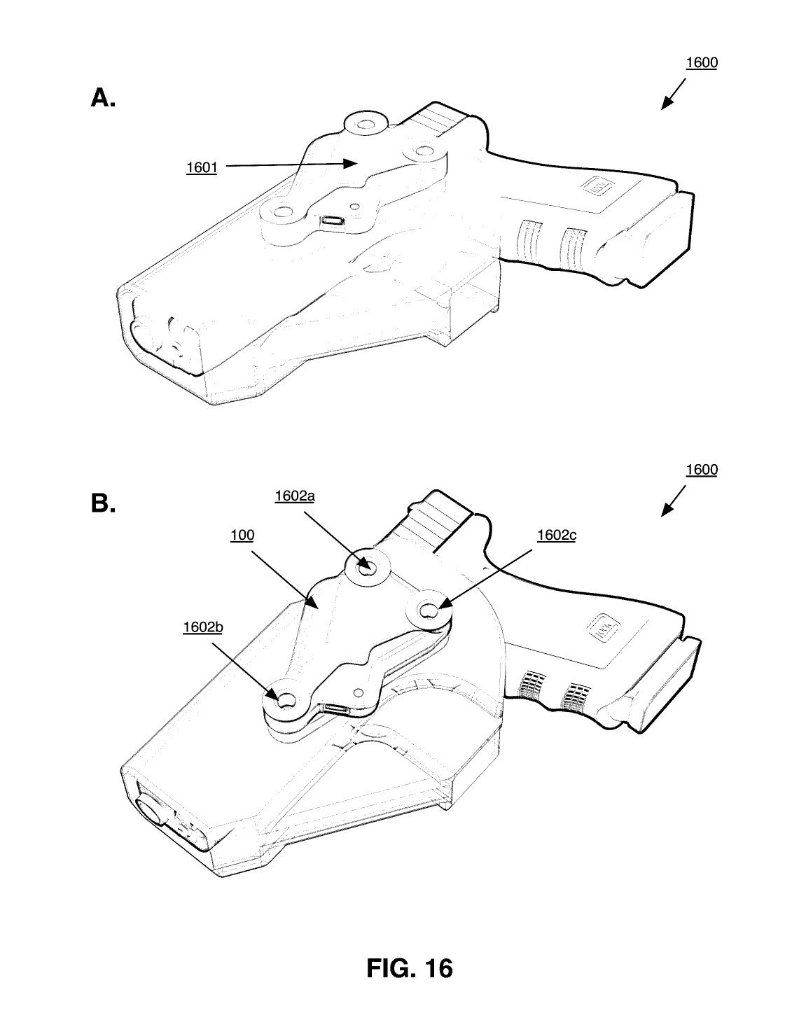

In certain embodiments, a telematics device 100 may be installed at standard attachment sites on a mount, such as a holster, as described below with respect to FIGS. 16-18. Such an attachment may constitute one example of mounting a telematics device 100 on a mount. In certain other embodiments, mounting a telematics device on a mount may include integrating the telematics device within a customized or standard mount, or otherwise embedding the telematics device within the mount.

In some embodiments, the detection by telematics device 100 involves a passive radiating device, such as a magnet. Other times an active radiating device is used, such as a radio frequency transmitter. Sometimes the active radiating device is an RFID (Radio-frequency identification) element. When using a radiating device, a component is attached to the weapon or implement in question, and the proximity (distance) between the weapon/implement and the radiating device is determined.

In other embodiments an inductive coupling mechanism is used, whereby the presence or absence of metallic substance is determined.

Some embodiments employ a photo interruption mechanism (a.k.a. an “optical” method), whereby a beam of visible or invisible light is directed or reflected and its presence or absence is determined.

Still other embodiments measure for change in capacitance, also known as dielectric shift. Some embodiments track the similarities or differences in measurements reported by a chained set of accelerometers.

Certain embodiments opt for a strain gauge or a pressure gauge, while others utilize a mechanically-activated switch. Other embodiments may utilize biometric sensing mechanisms to determine the presence and arrangement of the human user of the weapon or object.

Some means of detection necessitate the use of one or more antennas. When this is the case, some embodiments will utilize antennas external and remote to the primary apparatus (i.e., telematics device 100), enabling independent placement for optimal sensing integrity. Other embodiments will integrate and house antennas within the body of the telematics device 100.

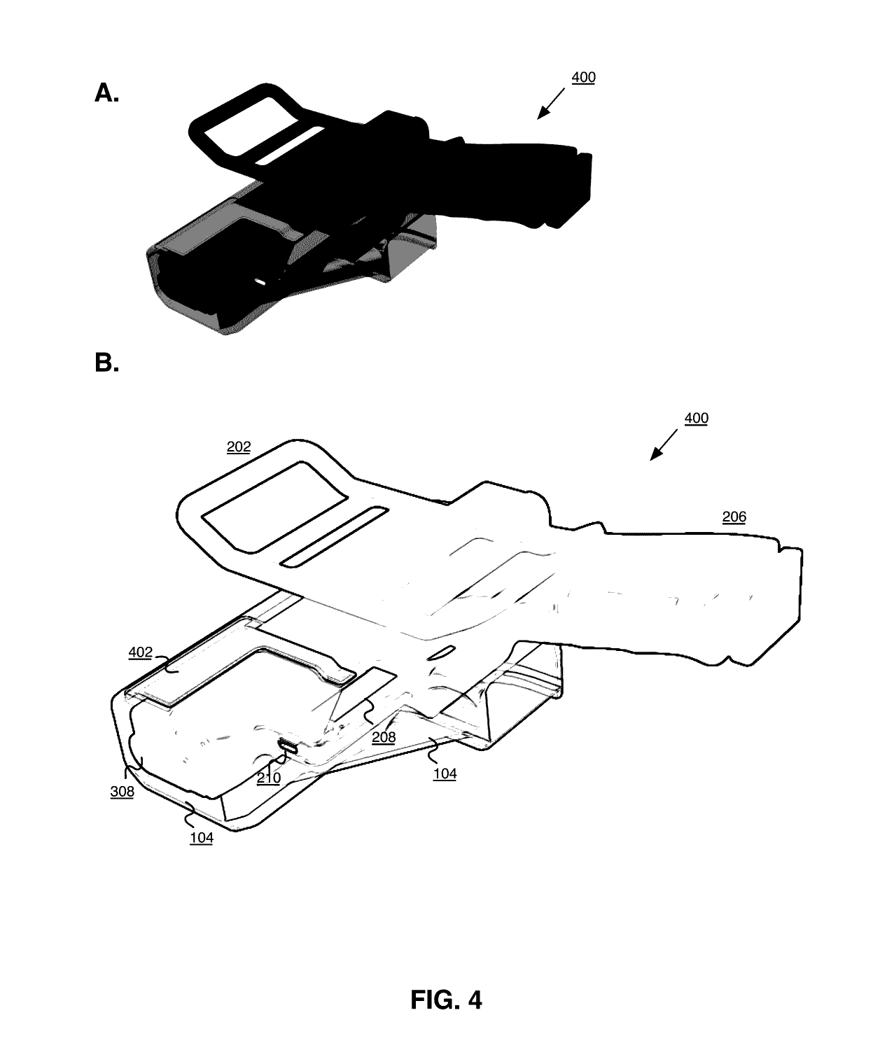

FIG. 4 shows views of an exemplary holster telematics system 400. In the embodiment shown here, holster telematics device 100 includes an antenna 402 (in addition to battery 208 and port 210), for detecting the presence of a firearm by monitoring changes in capacitance (dielectric shift). In certain embodiments, antenna 402 may be directly integrated into the materials of the holster; in other embodiments, antenna 402 is attached to the surface of holster 104, e.g., using an adhesive material.

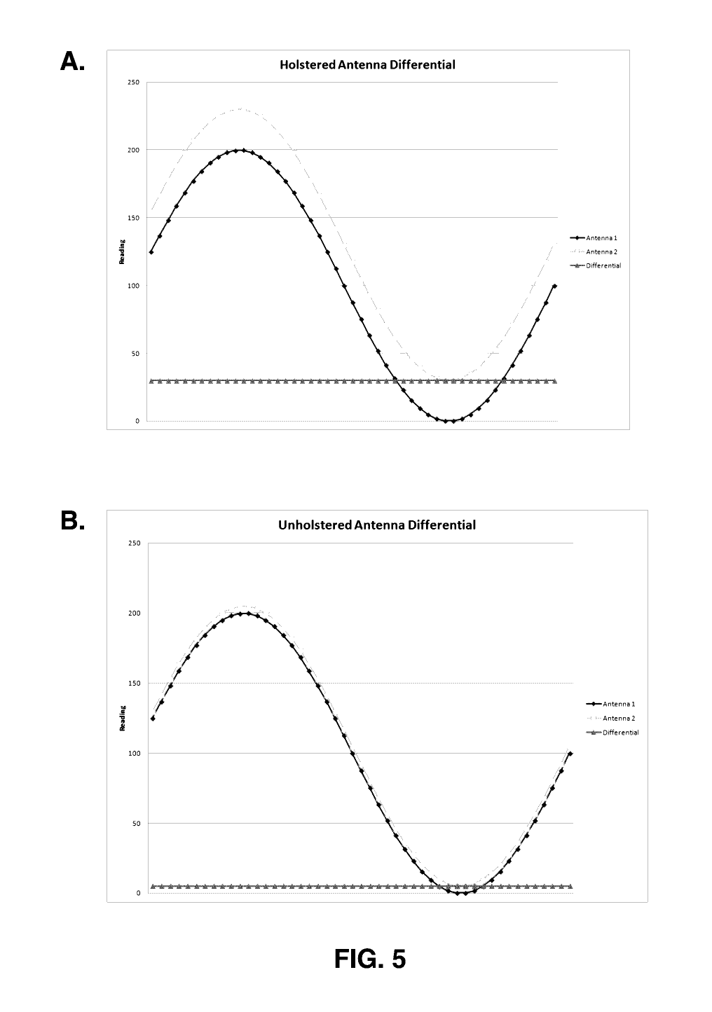

FIG. 5 shows exemplary data concerning monitoring the status of an implement on a mount using a dielectric-shift-based mechanism. Detecting dielectric environmental changes may be used to detect the near-presence of conductive materials, including metals. Water/humidity exhibits a similar electric field disruption to that of metal. In certain embodiments, telematics device 100 resolves such water/humidity issues through design use of a dual-antenna system, where one antenna senses the “ambient” dielectric measurement (and is positioned further away from the holstered implement). The other antenna is positioned closer to the holstered asset such as the barrel. This dual antenna configuration allows software calibration to identify and compensate for environmental effects. As shown in FIG. 5B, when the firearm is not holstered, both antennas exhibit identical results. As shown in FIG. 5A, when the firearm is holstered (even in the presence of high humidity), the antenna closest to the barrel will exhibit a signal that is differentially higher. In certain embodiments (e.g., in the system 400 shown in FIG. 4) antenna 402 may include two antennae side by side or sandwiched to implement a dielectric-shift-based sensor.

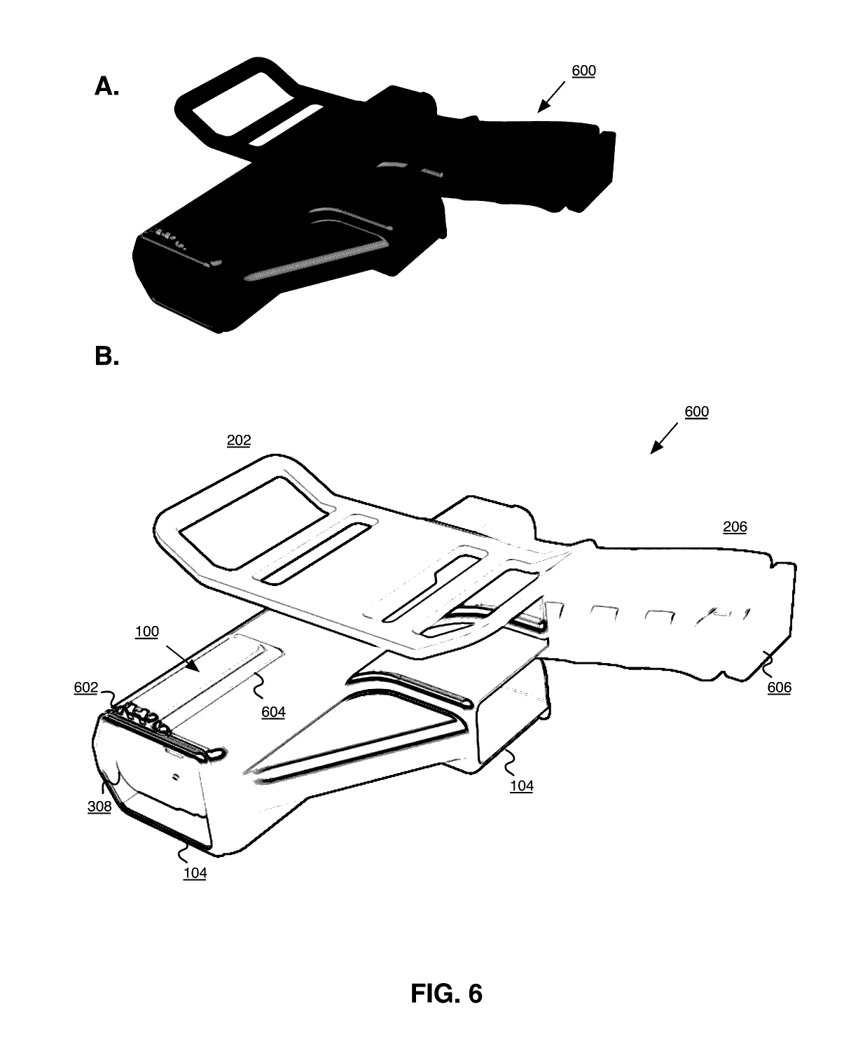

FIG. 6 shows views of an exemplary holster telematics system 600. In the embodiment shown here, telematics device 100 is encased within a rubberized casing or attachment structure 604. Also shown are exposed contacts 602, which pair to contacts on a charger that may be used to charge device 100. In this view, magazine 606 of the holstered handgun is shown.

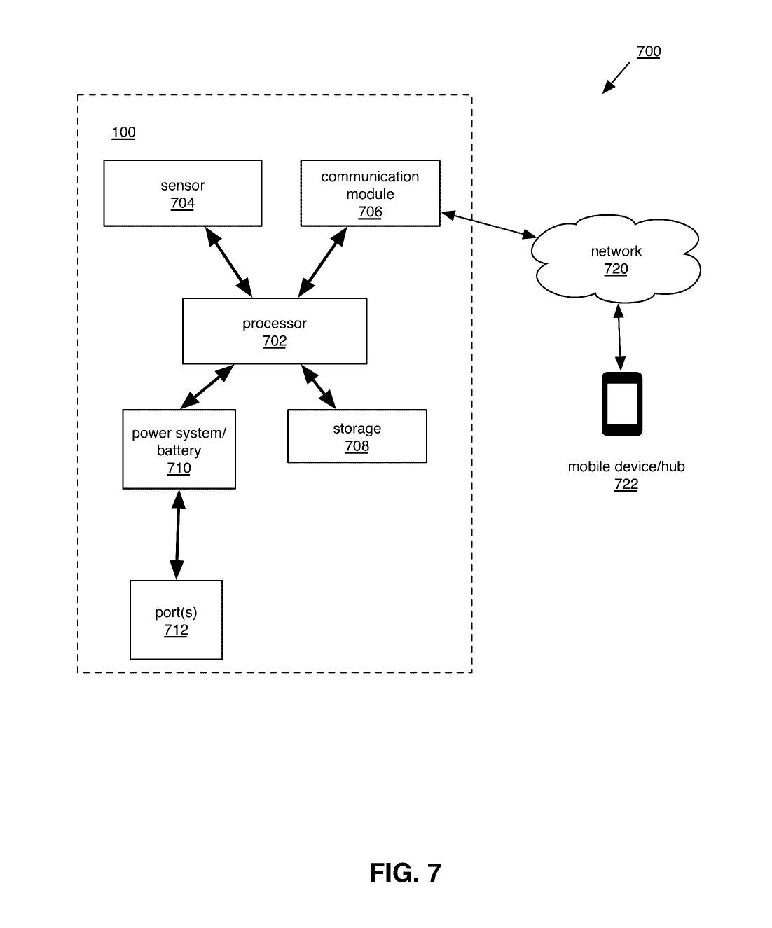

FIG. 7 shows a block diagram of a telematics device 100 in communication with a mobile device/hub 722. Exemplary telematics device 100 includes a processor 702 that may be in communication with one or more sensors 704, a communication module 706, a storage component 708, and a power system and/or battery 710. The power system/battery 710 may be in communication with one or more port(s) 712 (e.g., port 210).

Telematics device 100 may include one or more sensors 704—e.g., a temperature sensor for monitoring thermal load or ambient temperature, an accelerometer, a magnetometer, a gyroscope, a metal sensor (e.g., inductive coupling sensor components), optical/light sensor, microphone, etc. Communication module 706 may include a subscriber identity module (SIM) card, cellular radio, Bluetooth radio, ZigBee radio, Near Field Communication (NFC) radio, wireless local area network (WLAN) radio, GPS receiver, and antennas used by each for communicating data over various networks. Storage 708 may include one or more types of computer readable medium, such as RAM, optical storage devices, or flash memory, and may store an operating system, applications, and communication procedures. The power system/battery 710 may include a power management system, one or more power sources such as a battery and recharging system, a power status indicator, and the like.

Telematics device 100 may operate in various power/activity states, for example, in order to conserve battery life. For example, telematics device 100 may have an “off” state with no function, and a low power or “sleep” state, in which only limited function is available, such as the function of receiving an instruction to wake to transition to an active state. Telematics device 100 may have full functionality in an active state. Telematics device 100 may have additional intermediate states in which only certain functions are active, for example some sensing functions but not others, or some communications functions but not others.

Certain embodiments, such as system 700, include mobile device 722 as well as telematics device 100. In certain embodiments, mobile device 722 (which may function as a hub device relative to telematics device 100 and any other telematics devices associated with the operator) may be a smartphone, a smart watch, a tablet computer, or a radio, such as a police radio. In system 700, mobile device 722 is in communication with telematics device 100 via network 720. Network 720 may include a personal area network (PAN) such as Bluetooth or ZigBee, a local area network (LAN), a wired or wireless network, private or public network, or the internet, including wireless communication protocols such as General Packet Radio Service (GPRS), Enhanced Data rates for GSM Evolution (EDGE), 3G, 4G, Long Term Evolution (LTE) protocols, and communication standards such as Project 25 (P25), Terrestrial Trunked Radio (TETRA), and satellite and/or field radio protocols.

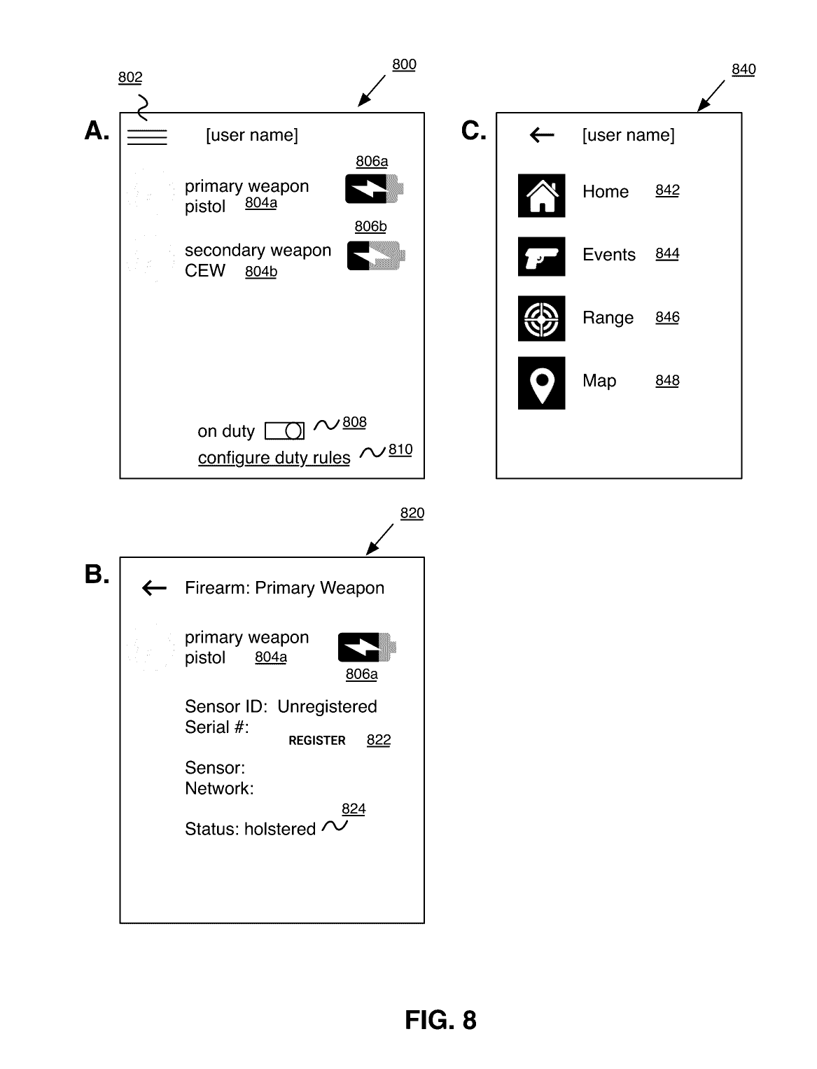

FIG. 8 shows three exemplary user interfaces for use in a system including monitoring of implement status on a mount. FIG. 8A shows a user interface 800 displaying a list of firearms 804 available in a system including monitoring of implement status. In one embodiment of such a system, each firearm 804 is associated with a battery-powered accessory device, and the status of the battery for each device is shown using icons 806. As shown, the accessory device associated with firearm 804a has greater charge remaining than firearm 804b. User interface 800 further includes an on-duty toggle 808 to control whether the system should monitor the associated firearms in “on duty mode” vs. “off duty mode”. For example, a user may desire a different rule set to apply with respect to camera activation while the user is on duty vs. off duty—for example, a user may desire to have an associated camera not be activated while the user is off duty (e.g., at the shooting range) and an associated firearm is discharged, because the resulting camera footage may not be of interest. User interface 800 may include a link to a settings menu 810 allowing the user to configure rules for on- and off-duty states. User interface 800 may further provide a drop-down menu 802 to access additional options, e.g., user interface 840 shown in FIG. 8C.

In certain embodiments, telematics device 100 may monitor/detect an implement's presence in the mount (e.g., holster 104) and may, for example, record related data in storage 708 at a frequency of: at least once every second, five times every second, or 20 times every second.

In certain embodiments, telematics device 100 may communicate the current status of the implement's presence in the mount (e.g., whether a firearm is holstered or not) to another device over network 720 at a frequency of: at least once per minute, once every 20 seconds, every five seconds, every second, or five times every second.

In certain embodiments, the system may distribute an updated rule set in real time to one or more local systems (where a local system is one or more of the following devices that may be associated with a single user: telematics device 100, firearm sensors, cameras, and mobile device 722). An updated rule set may be distributed at any time, for example, on a regular schedule or on an as-needed basis. The updated rule set may change the configuration of behavior in response to the identification of one or more types of events, or may change how an event is identified. In certain embodiments, an updated rule set may include an instruction to generate a notification upon receiving the updated rule set. In certain embodiments, distribution of the updated rule set may be triggered by an instruction from a remote command center (e.g., by way of web client 1102 and/or server 1110). For example, if a team of users is entering a dangerous area, a user at a remote command center may cause the system to distribute an updated rule set to all users of the team instructing each local system to immediately send a notification to all users of the team and to the command center upon any unholstering event.

In certain embodiments, telematics sensor 100 is capable of identifying one or more of the following potential states concerning unholstering: holstered; implement holstered and not being touched by operator; implement holstered and touched by operator (e.g., hand on weapon); implement partially unholstered; implement fully unholstered; implement unholstered and touched by operator (e.g., weapon drawn).

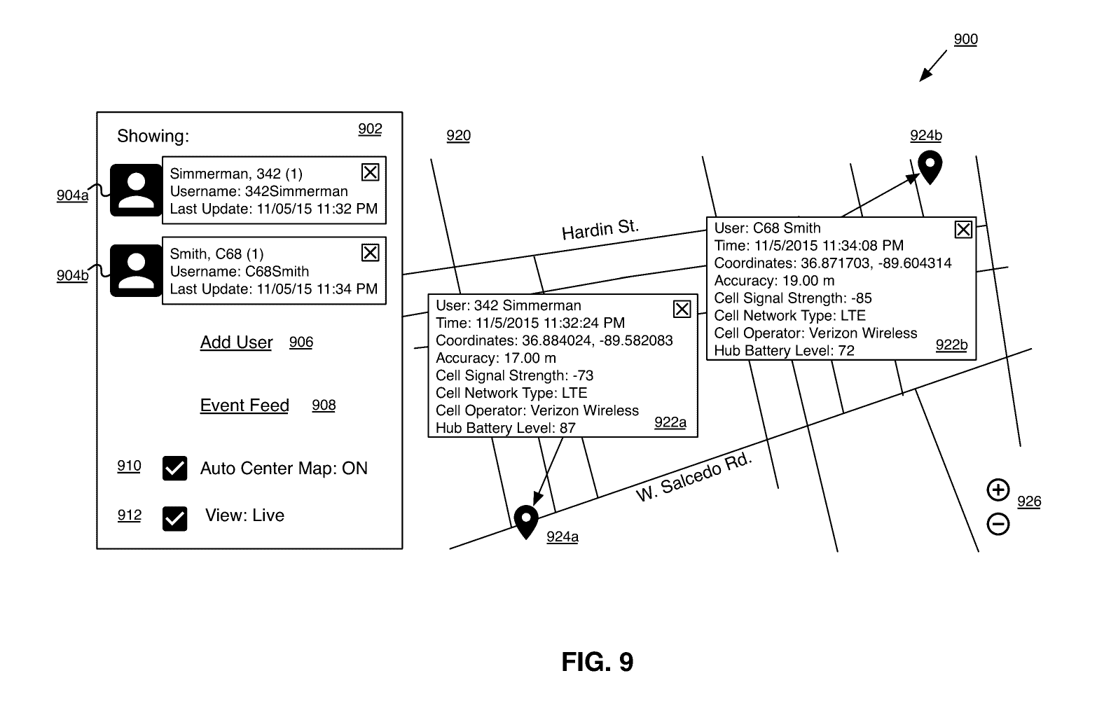

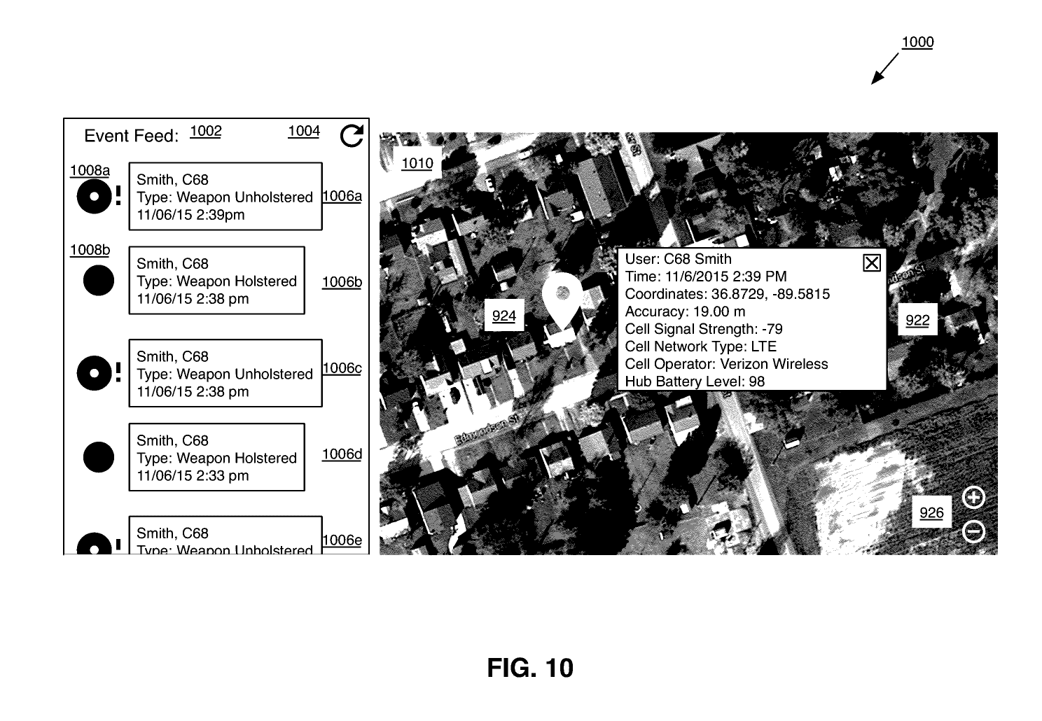

In some embodiments, selecting a particular firearm 804 in user interface 800 may display user interface 820, shown in FIG. 8B. User interface 820 may be used to register a firearm telematics sensor upon selecting register button 822. Such an interface may be further modified to display additional information about the charging status for the firearm telematics sensor that is associated with firearm 804a. User interface 820 may also display additional information about a firearm and its associated system components—e.g., firearm telematics sensor, charging devices, hub devices—e.g., that the current status of the firearm is “holstered” based upon the status information provided by a holster telematics sensor 100 (824). A hub device may be a mobile device that is paired with or local to a firearm telematics sensor and/or holster telematics device 100, e.g., mobile device 722. For example, the information may include the location of each component plotted on a map, the serial number or ID for the components, the user associated with each component, whether/how each component is connected to a network and/or links to other UIs for displaying such information, such as the interfaces shown in FIGS. 9-10).

FIG. 8C shows an exemplary user interface 840 providing access to a home link 842, an events link 844 (see, e.g., FIG. 10), a range link 846 concerning use at a gun range, and a map link 848 for accessing a display of the locations of system components (see, e.g., FIGS. 9-10).

FIG. 9 shows an exemplary user interface for use in a system including monitoring of implement status on a mount. Such an interface may be used for displaying the locations of system components (e.g., a firearm and associated holster telematics device 100 and, e.g., a firearm telematics sensor). Panel 902 provides a listing of two users 904a and 904b; components associated with those users are displayed on a map in panel 920. Panel 902 further provides a link 906 to add an additional user to the display, and a link 908 to access an event feed (see FIG. 10). Toggle 910 controls a map centering option and toggle 912 controls whether the display in panel 920 updates to display live information or stops refreshing.

Map panel 920 marks the location of the components associated with the users on the map using location markers 924. The map may be stylized as shown, or may constitute a satellite photograph. A user may adjust the scale of the map using controls 926. Additional information associated with the components at each location 924 is displayed in an overlay window 922. For example, the overlay window 922 provides information about (1) the user associated with the component(s) at the location; (2) the time stamp associated with the information; (3) the coordinates of the location; (4) the accuracy/error estimate for the location; (5) information about the network type, strength, and operator; (6) hub device battery status. In certain embodiments, additional information about camera status could be provided as well.

FIG. 10 shows an exemplary user interface 1000 for use in a system including monitoring of implement status on a mount. User interface 1000 may be used to view an event feed (panel 1002) alongside the locations associated with each event (displayed in panel 1010, showing a satellite image for the map). Panel 1002 may display individual events 1006 (e.g., status change from “Weapon Holstered” to “Weapon Unholstered”, or the reverse, or simply a list of the status for each component being monitored each time it is reported by a hub device or directly from another component such as a holster telematics device 100), along with additional information such as the associated user name, a time stamp, and the event type. Events may be associated with icons 1008 to quickly indicate the category of event. An event feed may be manually refreshed using a control 1004—for example, in certain embodiments, this may cause the system to poll each component to report its current status, or in other embodiments, it may update the list of components being tracked and/or displayed in user interface 1000.

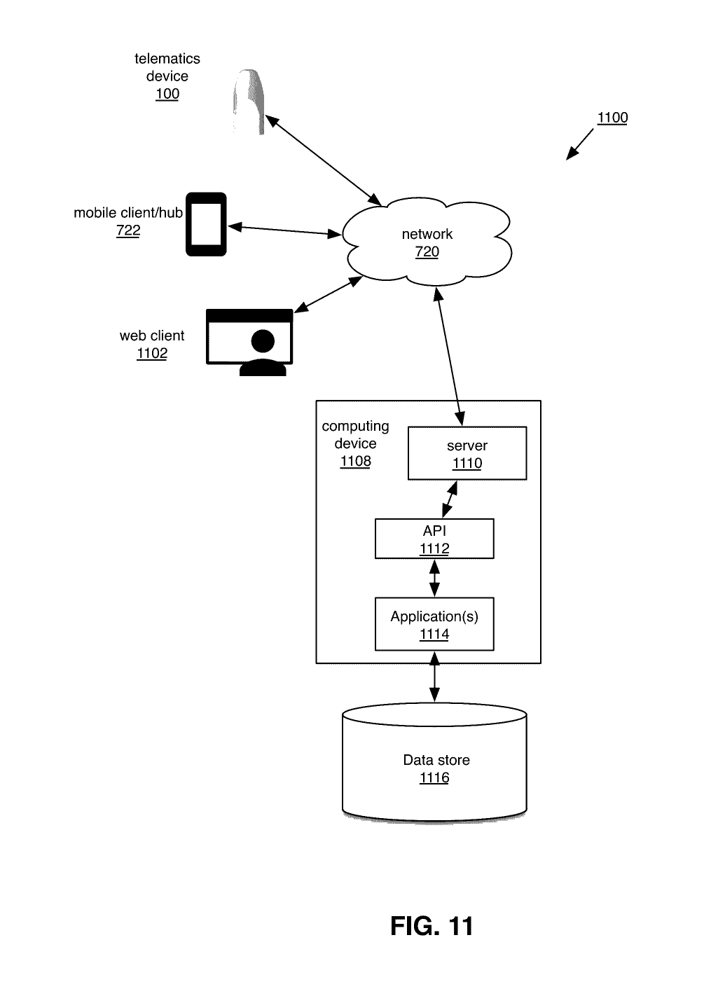

FIG. 11 is a block diagram showing exemplary data flows for an exemplary system 1100. In certain embodiments, data regarding the status of a component of system 1100 and or the environment of system 1100 (including, for example, a firearm and a holster) may be generated at holster telematics sensor(s) 100 and/or mobile device 722. In certain embodiments, this data may be shared between components of the system (e.g., holster telematics sensor(s) 100 and/or mobile device 722) on a personal area network such as a Bluetooth or ZigBee even in the absence of a wireless connection providing communication with geographically remote devices (e.g., the device executing web client 1102 or computing device 1108 hosting server 1110). Web client 1102 may be executed at a command and control center (e.g., for police, military, or security professionals). All components of the system 1100 are directly or indirectly connected using a combination of communication protocols represented by network 720.

In certain embodiments, one or more computing devices 1108 hosts a server 1110, such as an HTTP server, and an application 1114 that implements aspects of the remote monitoring system (e.g., a situational intelligence platform). For example, status-related files and/or user account information may be stored in data store 1116. Application 1114 may support an Application Programming Interface (API) 1112 providing external access to methods for accessing data store 1116. In certain embodiments, client applications running on client devices 100, 722, and 1102 may access API 1112 via server 1110 using protocols such as HTTP or FTP.

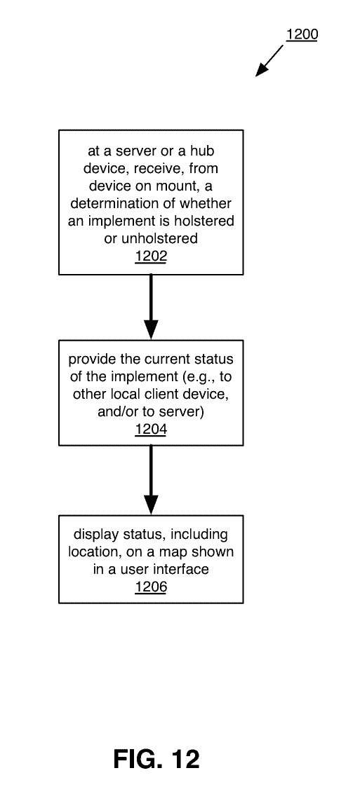

FIG. 12 is a flow chart depicting an exemplary method 1200 for monitoring the status of an implement on a mount. First, in step 1202, a server (e.g., server 1110) or hub device (e.g., mobile device 722) receives a status update from telematics device 100 at a mount, such as a holster. The status update indicates whether the implement corresponding to telematics device 100 is present at the mount, or absent (i.e., unholstered). In certain embodiments, such a status update communication is triggered by a change in status (e.g., device 100 detects that a weapon is no longer holstered, or device 100 changes geographic location). Current geographic location may be assessed using GPS (global positioning service), as assessed by, e.g., telematics device 100 or mobile device 722. In certain embodiments, a change in location may be assessed by either of telematics device 100 or mobile device 722. In certain embodiments, device 100 provides such an update on a regular frequency, such as every 5 seconds, 1 second, half second, or the like.

In step 1204, the receiving device (e.g., server 1110 or mobile device 722) provides the current status of the implement (e.g., holstered/unholstered and/or location of the implement) to another device, such as a client device of a team member (e.g., another mobile device), or distributes the status system-wide to other client devices, via server 1110.

In step 1206, a receiving client device displays the status to a user, e.g., using a user interface plotting the location and other status information regarding an implement and its operator such as user interface 900 or 1000 shown in FIGS. 9 and 10. In certain embodiments, rather than providing the status via a map-oriented user interface, the receiving device will instead display an alert or a notification. In certain embodiments, the notification may constitute or include an alert message to communicate a dangerous situation to dispatch and/or unit members. An alert may be a prominent notification displayed on, for example, a mobile device 722 or web client 1102.

The consequence of identifying a holstering or unholstering event may be configured, e.g. through a user interface accessed via link 810 in user interface 800, and such configurations may be retained in data store 1116, telemetry device 100, and/or mobile device 722.

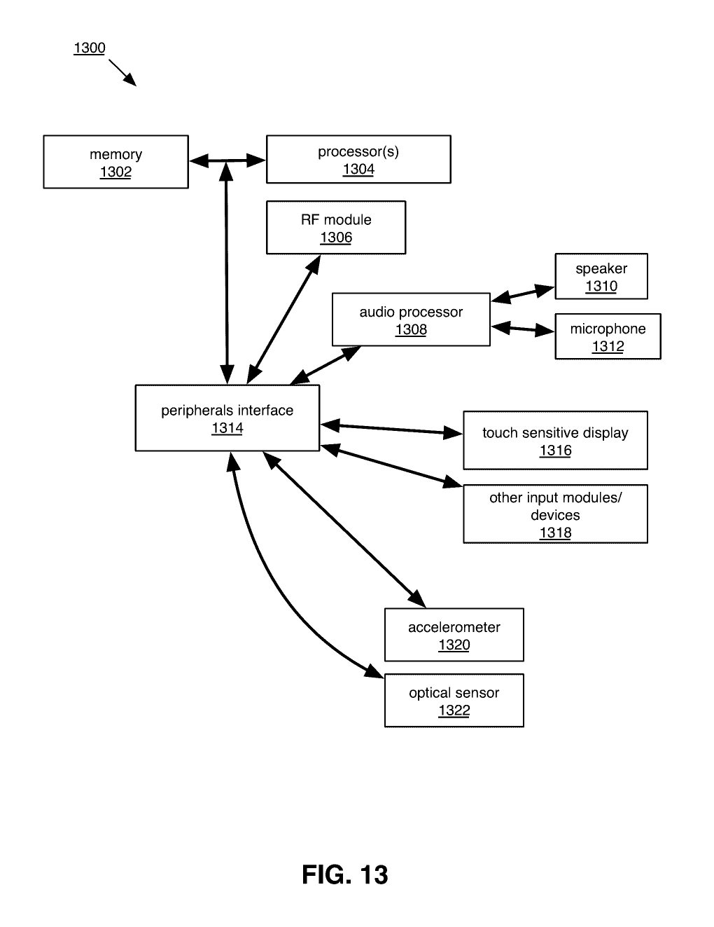

FIG. 13 is a block diagram showing an exemplary mobile computing device, consistent with some embodiments of the invention;

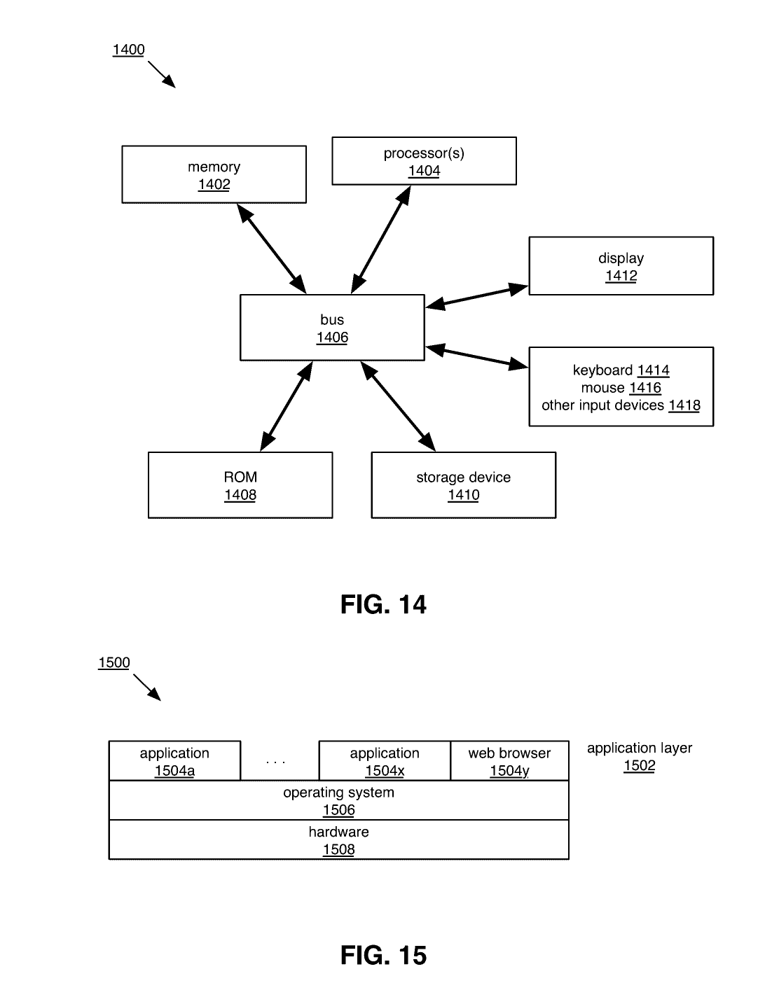

FIG. 14 is a block diagram showing an exemplary computing device, consistent with some embodiments of the invention;

FIG. 15 is a block diagram showing an exemplary computing system, consistent with some embodiments of the invention.

FIG. 13 is a block diagram showing an exemplary mobile computing device (e.g., mobile device 722). The device 1300 may have a memory 1302 which may include one or more types of computer readable medium, such as RAM, optical storage devices, or flash memory. Memory 1302 may store an operating system, applications, and communication procedures. Device 1300 may include one or more data processors, image processors, or central processing units 1304. Device 1300 may include peripherals interface coupled to RF module 1306, audio processor 1308, touch sensitive display 1316, other input modules/devices 1318, accelerometer 1320 and optical sensor 1322.

RF module 1306 may include a cellular radio, Bluetooth radio, NFC radio, WLAN radio, GPS receiver, and antennas used by each for communicating data over various networks.

Audio processor 1308 may be coupled to a speaker 1310 and microphone 1312. Touch sensitive display 1316 receives touch-based input. Other input modules or devices 1318 may include, for example, a stylus, voice recognition via microphone 1312, or an external keyboard.

Accelerometer 1320 may be capable of detecting changes in orientation of the device, or movements due to the gait of a user. Optical sensor 1322 may sense ambient light conditions, and acquire still images and video.

FIG. 13 is a block diagram showing an exemplary computing system 1400 that is representative any of the computer systems or electronic devices discussed herein. Note, not all of the various computer systems have all of the features of system 1400. For example, systems may not include a display inasmuch as the display function may be provided by a client computer communicatively coupled to the computer system or a display function may be unnecessary.

System 1400 includes a bus 1406 or other communication mechanism for communicating information, and a processor 1404 coupled with the bus 1406 for processing information. Computer system 1400 also includes a main memory 1402, such as a random access memory or other dynamic storage device, coupled to the bus 1406 for storing information and instructions to be executed by processor 1404. Main memory 1402 also may be used for storing temporary variables or other intermediate information during execution of instructions to be executed by processor 1404.

System 1400 includes a read only memory 1408 or other static storage device coupled to the bus 1406 for storing static information and instructions for the processor 1404. A storage device 1410, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 1404 can read, is provided and coupled to the bus 1406 for storing information and instructions (e.g., operating systems, applications programs and the like).

Computer system 1400 may be coupled via the bus 1406 to a display 1412 for displaying information to a computer user. An input device such as keyboard 1414, mouse 1416, or other input devices 1418 may be coupled to the bus 1406 for communicating information and command selections to the processor 1404.

The processes referred to herein may be implemented by processor 1404 executing appropriate sequences of computer-readable instructions contained in main memory 1402. Such instructions may be read into main memory 1402 from another computer-readable medium, such as storage device 1410, and execution of the sequences of instructions contained in the main memory 1402 causes the processor 1404 to perform the associated actions. In alternative embodiments, hard-wired circuitry or firmware-controlled processing units (e.g., field programmable gate arrays) may be used in place of or in combination with processor 1404 and its associated computer software instructions to implement the invention. The computer-readable instructions may be rendered in any computer language including, without limitation, Objective C, C#, C/C++, Java, assembly language, markup languages (e.g., HTML, XML), and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1400 or similar electronic computing device, that manipulates and transforms data represented as physical (electronic) quantities within its registers and memories into other data similarly represented as physical quantities within its memories or registers or other such information storage, transmission or display devices.

FIG. 15 illustrates a computer system 1500 from the point of view of its software architecture. Computer system 1500 may be any of the electronic devices or, with appropriate applications comprising a software application layer 1502, may be a computer system for use with the monitoring system described herein. The various hardware components of computer system 1500 are represented as a hardware layer 1508. An operating system 1506 abstracts the hardware layer and acts as a host for various applications 1504, that run on computer system 1500. The operating system may host a web browser application 1504y, which may provide access for the user interfaces, etc.

FIG. 16 shows views of an exemplary holster telematics device within a holster system 1600. In certain embodiments, telematics device 100 is attached within an interposer 1601 that sits between the holster and, for example, a utility belt (e.g., utility belt 102). Such an attachment may constitute one example of mounting a telematics device 100 on a mount. For example, certain off-the-shelf holsters attach to an attachment site a utility belt using a standard attachment mechanism, for example, one or more screws, rivets, or bolts. The embodiment shown here is designed for an attachment mechanism using three screws. The screws may be inserted into screw holes 1602 of an interposer 1601 containing the embodiment of telematics device 100 shown in FIG. 16.

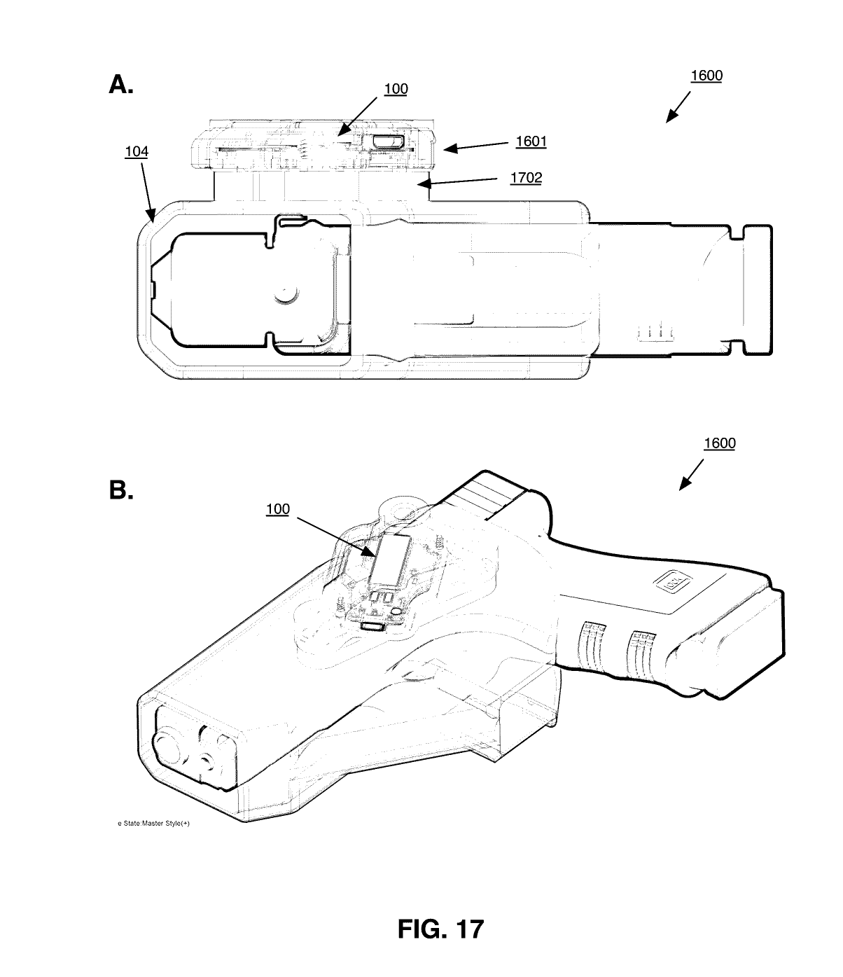

FIG. 17 shows views of an exemplary holster telematics device within a holster system 1600. View 17A shows a rear view of holster system 1600, including interposer 1601 that provides screw holes 1602 that may correspond to both an attachment site on an off-the-shelf holster (e.g., holster attachment point 1702) and a belt attachment site (not shown). The telematics device 100 may thus be held within interposer 1601 and be attached to the standard attachment mechanism for a utility belt and holster or other type of mount. In certain embodiments, screws may be used to attach the interposer 1601, telematics device 100, and holster 104. View 17B. shows some of the components of telematics device 100, including battery 208.

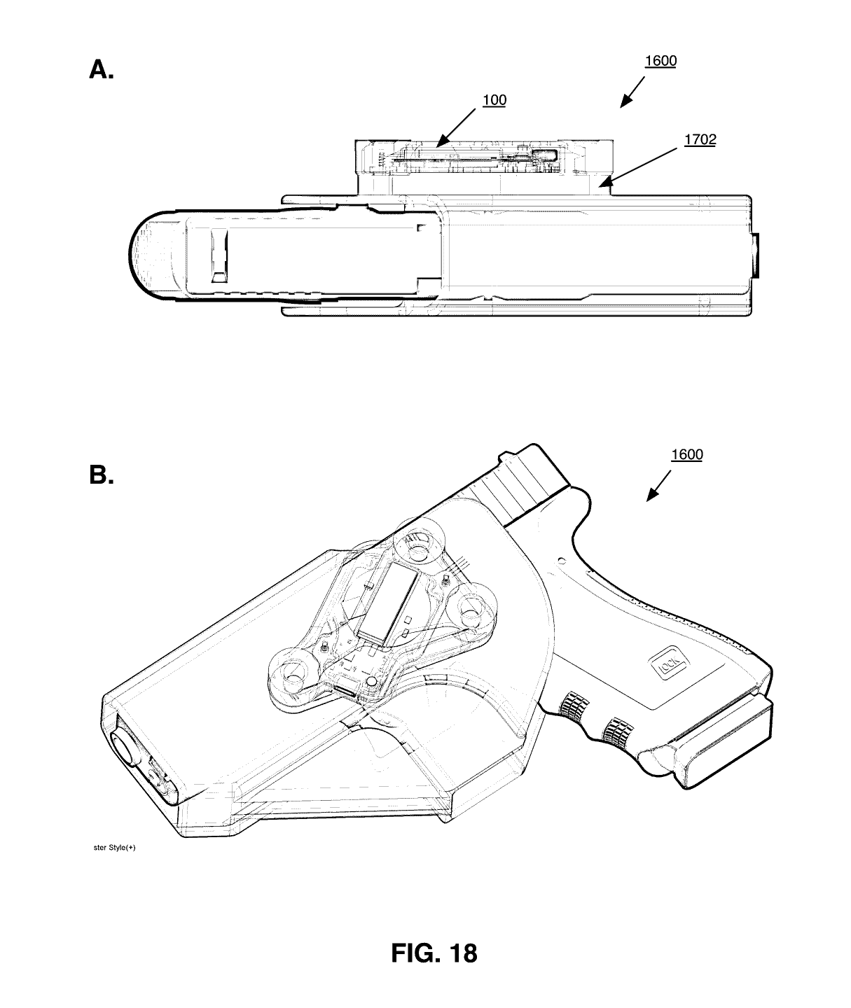

FIG. 18 shows views of an exemplary holster telematics device within a holster system 1600. View 18A shows a top view of holster system 1600, including a structure providing holster attachment point 1702.

### Examples

Exemplary procedure to enable function of one embodiment of telematics sensor 100:

(1) CPU initialization and power-up

(2) Self-calibration

(3) Duty-cycle for power savings

Set timer

Sleep

Timer fires; sensor wakes up
Conduct measurement
Decision Point:

Compare measurement against previous state

If necessary, determine sub-state (no touch; hand on weapon; weapon drawn)

Store result

Compile results into an aggregate result, a ‘profile’

Report State

Jump to beginning of duty-cycle and repeat

If REPORT, examine report

Determine whether REPORT belongs to subset of types of REPORTs configured to be reported

Store and transmit REPORT

Monitor power

If power is low, indicate as such and transmit status

Jump to (3) and repeat

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

What is claimed is:

1. A system for detection of the status of an implement on a mount, comprising:
the implement that is attached to the mount, wherein the mount is a holster or a gun rack;
a telematics device attached on or near the mount, the telematics device comprising:
one or more memories storing instructions and one or more processors that execute the instructions by:
monitoring the status of the mount, wherein the status includes detecting whether or not the implement is present;
communicating the status of the mount.

2. The system of claim 1, wherein the implement is selected from the group consisting of: a lethal weapon, a nonlethal weapon, a policing implement, a camera, an ammunition-related implement, and a radio.

3. The system of claim 1, wherein the telematics device uses inductive coupling to detect the presence or absence of the implement.

4. The system of claim 1, wherein the telematics device uses a dielectric-shift-based mechanism to detect the presence or absence of the implement.

5. The system of claim 1, wherein the status of the mount is provided to a mobile device via a personal area network.

6. The system of claim 1, wherein the status of the mount is communicated to a server.

7. The system of claim 1, wherein the status of the mount is communicated in real time.

8. The system of claim 1, wherein the mount is a holster, and the telematics device is external to an interior cavity of the holster.

9. The system of claim 1, wherein the telematics device is attached to the mount using a reversible adhesive or an interposer, and the mount is off-the-shelf.

10. The system of claim 1, wherein the telematics device is configured to wirelessly receive instructions to suspend or resume status monitoring, and to wirelessly receive a profile including parameters for detecting the presence or absence of an implement.

11. The system of claim 1, wherein the status of the mount further comprises the location of the mount.

12. A method for sharing the status of an implement on a mount, comprising:
receiving, from a telematics device mounted on the mount, a determination of whether the implement is holstered or unholstered, wherein the determination is received one or more times per minute;
providing the current status of the implement, wherein the current status comprises the latest determination and the location of the implement.

13. The method of claim 12, wherein the determination and the location are received by way of a mobile device in communication with the telematics device mounted on the mount, and the current status is provided via a user interface that includes changes in status and displays the location of the implement on a map.

14. The method of claim 12, wherein the determination and the location were received at a mobile device, and the current status of the implement as well as the current status of other implements are provided via a graphical user interface that displays the status of each implement on a map.

15. The method of claim 14, wherein the statuses displayed on the map were obtained via a personal or local area network without relaying communications via a remote server.

16. The method of claim 12, wherein the determination is updated one or more times per five seconds.

17. The method of claim 12, wherein the determination is updated one or more times per second.

18. The method of claim 13, wherein the mobile device is a radio.

19. The method of claim 13, wherein the mobile device provides the user interface.

20. The method of claim 13, wherein a client device that is different from the mobile device provides the user interface.

21. The method of claim 12, wherein the current status is provided as an alert message.

22. A method for sharing the status of an implement on a mount, comprising:
receiving, at a first telematics device, from a second telematics device mounted on the mount, a determination of whether the implement is holstered or unholstered, wherein the determination is updated one or more times per minute;
performing one or more automated task.

23. The method of claim 22, wherein the one or more automated task is one or more of initiating forensic logging, opening a radio channel, and waking from a sleep state.
